(19) United States
(12) Patent Application Publication
(10) Pub. No.: US 2012/0239361 A1
(43) Pub. Date: Sep. 20, 2012

(54) Subsurface Directional Equalization Analysis of Rock Bodies

(76) Inventor: J.A. Vargas-Guzman, Dhahran (SA)

(21) Appl. No.: 13/049,063

(22) Filed: Mar. 16, 2011

(51) Int. Cl. G06G 7/48

(52) U.S. Cl. 703/6

(57) ABSTRACT

A subsurface directional analysis determines an image-based three-dimensional analysis meta-model with unbiased vectors and tensor relations among rock bodies or complex objects in the directional subsurface environment. An analytical tool is applied to sequence stratigraphy for characterization of geological heterogeneity of developed hydrocarbon reservoirs, aquifers and sequences of rocks.

### BACKGROUND OF THE INVENTION

1. Field of the Invention

The present invention relates to determining models of the relationship of rock bodies or complex objects in the earth to evaluate recoverable hydrocarbons and other geological information of interest.

2. Description of the Related Art

Ultimate recovery of hydrocarbons from reservoir fluids heavily depends on the three dimensional (3D) delimitation of rock bodies. The spatial distribution and flow of fluids must be constrained to the spatial delimitation of rock type regions and properties (i.e., petrophysical properties and fluid saturation geocellular models). The exact spatial location of rock bodies at non-sampled locations is almost unpredictable, and one must resort to high-frequency sequence stratigraphy that can be used for advanced probability studies and predictions of sedimentary deposition.

State of the art facies analysis has so far as is known been based on the following workflow: (a) Core descriptions were performed at cored wells; (b) Sequence stratigraphy studies were developed to generate a conceptual sedimentological model to select analog outcrops and airborne images; (c) Facies maps were drawn to generate a semi-quantitative conceptual model; and (d) Core descriptions were used to predict facies categories at non-core wells by cluster analysis, neural networks or similar techniques.

The numerical understanding of sequences of rocks is usually based on quantitative computation of transition probabilities in vertical sequences. Walther's law allows for transposing vertical transitions to lateral and 3D sequences of rocks. Lateral deposition of rocks at regional resolution may also be simulated with physical models.

Dynamic modeling approaches have been devised based on the rate of sedimentation compared to the spatial gradient of sediment transport. The information from wells and interpretations must be integrated into a geocellular model of rock facies and properties. A number of technical limitations have been identified in the workflows. The main difficulty is that reservoir rocks are located at some several thousand feet in the subsurface. Therefore, seismic imaging at the required resolution is not possible yet. Furthermore, the amount of rock cores that can be available at a given reservoir is not large, and prediction of facies at non-cored wells from logging data may be limited by the logging tool resolution.

In addition to data collection limitations, there are computational limitations imposed by the mathematical approaches utilized for numerical analysis and modeling. Facies numerical analysis is based on analysis of vertical and lateral proportion curves and conceptual models. Transition probabilities follow the Markovian property which in practical terms states that a sequence of rocks can be decomposed in a chain of single rock occurrences or events. This is that one event at geological time (t) is conditional to another older event at time (t−1), and so forth, in a pair-wise fashion. This leads to a condition of independence between conditional events (i.e., Kolmogorov axioms). Such relations validate the use of products of probabilities to represent a joint event. For example, the probability of an event A is P(A) and the probability of a second event is P(B). The probability of B given A is abbreviated as P(B|A). If a third event is conditional to B, then P(C|B) is the conditional (transitional) Markovian probability. The probability of the third event given two prior events is wrongly proposed to be the product of P(C|B) by P(B|A). While such a product is valid for the Markovian model, it is rarely valid in realistic rock sequences.

Facies analysis modeling also faces similar limitations. For example, a sinuous shape as observed in meandering channels or other complex shaped bodies of rocks has not so far as is known been successfully modeled with second order sequential indicator simulation (SIS). It has been proposed that higher order connectivity could relax the limitation of SIS but a theoretical solution with higher order moments is intractable. Therefore, a practical way around was proposed using analog images of depositional environments. The proposal has been termed multipoint statistics, and it is based on scanning the probability of multiple location “data” events in a selected analog image. The approach is described in the literature.

Another way around the second order limitation of SIS was by using Boolean object modeling methods where the geobodies geometry was statistically simulated. The center of mass for each object was generated as a point process, and the objects were drawn as described by their simulated geometrical parameters. In a second stage, objects were moved to match well data with an optimization algorithm such as annealing.

The problem became a puzzle if bodies had to align with complex trends observed in well data. If the categorical well data was not in agreement with the geometry and size of the simulated objects, the results would not converge to a model conditional to the well data as expected. This was an issue when using object modeling with a large number of wells.

For example, one well with the wrong rock classification was enough to break the continuity expected to place a specific channel object. As a consequence, the data conditioning process with simulated annealing for hundreds of wells could take hundreds of hours of computer time. Such a difficulty may be resolved if the well data was really consistent with the proposed geometry of simulated objects. Such compatibility between objects and well data was also necessary between well data and analog images used in facies modeling with multipoint statistics. A link between object modeling and multipoint statistics was intuitively accepted; however a theoretical framework needed to be devised to unify and improve the three methods (i.e., multipoint, object simulation and SIS). Second order SIS and object modeling were linked with conditional proportions. A higher order unified model that can integrate satellite images with borehole data was, so far as is known, not available.

### SUMMARY OF THE INVENTION

Briefly, the present invention provides a new and improved computer implemented method of subsurface directional analysis of an area of interest with rock bodies having geological trends in the earth. The analysis has input data including geobody data and categorical data regarding the area of interest. The computer implemented method forms a measure of postulated proportions of rock joint events in the geological trends in the area of interest, and also forms a measure of spatial tensorial relations for projections along directions of the geological trends in the area of interest based on the measure of postulated proportions of rock joint events. The method projects the categorical data onto the measure of spatial tensorial relations and determines cross-structural relationships between the projected categorical data and the measure of spatial tensorial relations for expected pairs of directions and rock categories. The measure of spatial tensorial relations and the projected categorical data are equalized to form a meta-model of facies present in the area of interest and their directions, and a record is formed of the meta-model of facies.

The present invention also provides a new and improved data processing system for subsurface directional analysis of an area of interest with rock bodies having geological trends in the earth. The data processing system has input data including geobody and categorical data regarding the area of interest for the analysis. The data processing system includes a processor which forms a measure of postulated proportions of rock joint events in the geological trends in the area of interest, and forms a measure of spatial tensorial relations for projections along directions of the geological trends in the area of interest based on the measure of postulated proportions of rock joint events. The processor also projects the categorical data onto the measure of spatial tensorial relations and determines cross-structural relationships between the projected categorical data and the measure of spatial tensorial relations for expected pairs of directions and rock categories. The processor further equalizes the measure of spatial tensorial relations and the projected categorical data to form a meta-model of facies present in the area of interest and their directions and forms a record of the meta-model of facies.

The present invention also provides a new and improved data storage device having stored in a computer readable medium computer operable instructions for causing a processor to perform subsurface directional analysis of an area of interest with rock bodies having geological trends in the earth. The processor has as input data geobody and categorical data regarding the area of interest. The instructions stored in the data storage device cause the processor to form a measure of postulated proportions of rock joint events in the geological trends in the area of interest and form a measure of spatial tensorial relations for projections along directions of the geological trends in the area of interest based on the measure of postulated proportions of rock joint events. The instructions stored in the data storage device cause the processor to project the categorical data onto the measure of spatial tensorial relations and determine cross-structural relationships between the projected categorical data and the measure of spatial tensorial relations for expected pairs of directions and rock categories. The instructions stored in the data storage device further cause the processor to equalize the measure of spatial tensorial relations and the projected categorical data to form a meta-model of facies present in the area of interest and their directions, and form a record of the meta-model of facies.

### BRIEF DESCRIPTION OF THE DRAWINGS

FIG. 1 is a functional block diagram or flow chart of data processing steps for a subsurface directional analysis according to the present invention.

FIG. 2 is a schematic diagram of a computer system for subsurface directional analysis of rock bodies according to the present invention.

FIG. 3 is an example image data base which is used in the processing steps of FIG. 1.

FIG. 4 is a diagram illustrating an example diagram of a subsurface rock sequence.

FIGS. 5A, 5B, and 5C are diagrams of subsurface stratigraphy of an example portion of the earth.

FIG. 6 is a display, of tensor anisotropy obtained according to the present invention superimposed on an image an area of the earth with complex anisotropy in a fluvial deltaic environment with tidal components.

FIG. 7 is a compositional schematic representation of probability for three simultaneous events in a stratigraphic sequence.

FIG. 8 is a display of cumulants determined according to the present invention from facies proportions.

FIG. 9 is a schematic diagram of a stereonet plot used in connection with the process steps of FIG. 1 for 3D direction selection according to the present invention.

FIG. 10 is an example display or image adjusted to well data according to the present invention.

### DETAILED DESCRIPTION OF THE PREFERRED EMBODIMENTS

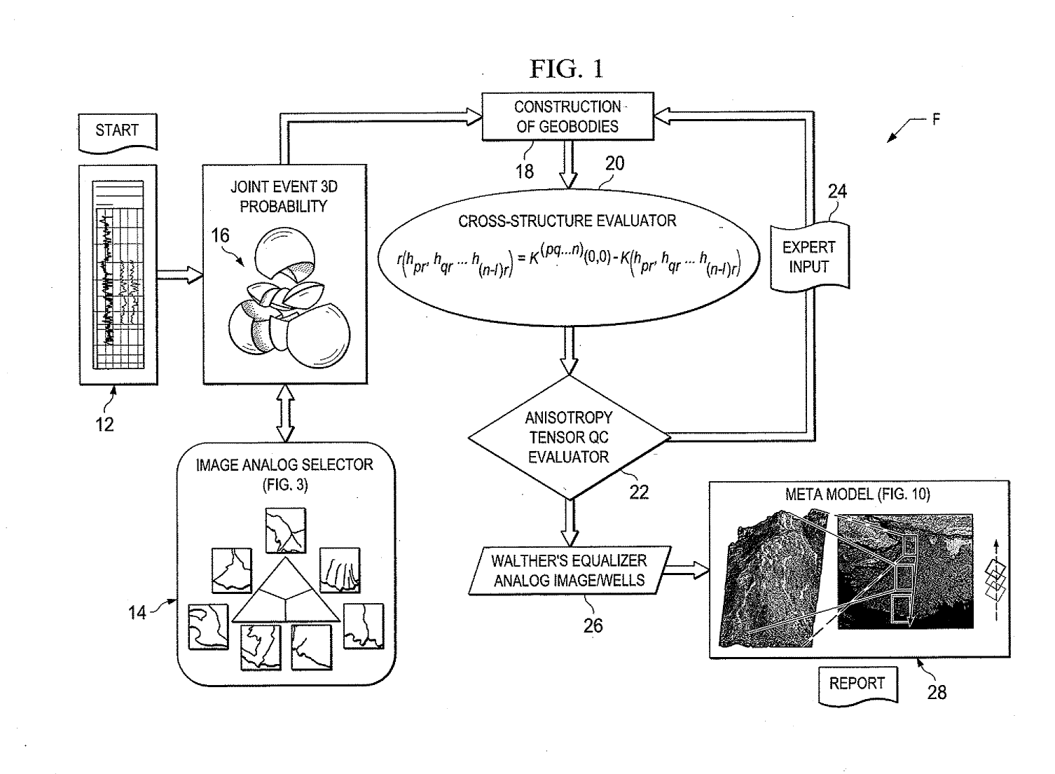

In the drawings, FIG. 1 is a diagram or flow chart F of data processing steps according to the present invention. As will be set forth, the present invention provides subsurface directional analysis for forming an image based facies three-dimensional (3D) meta-model with unbiased vectors and tensor relations among rock bodies or complex objects in the directional subsurface depositional environment. The present invention provides novel physical-spatial-statistical analytical computer modeling tools which are applied to sequence stratigraphy for the characterization of geological heterogeneity of developed industrial oil/gas reservoirs, aquifers and sequences of rocks in the subsurface.

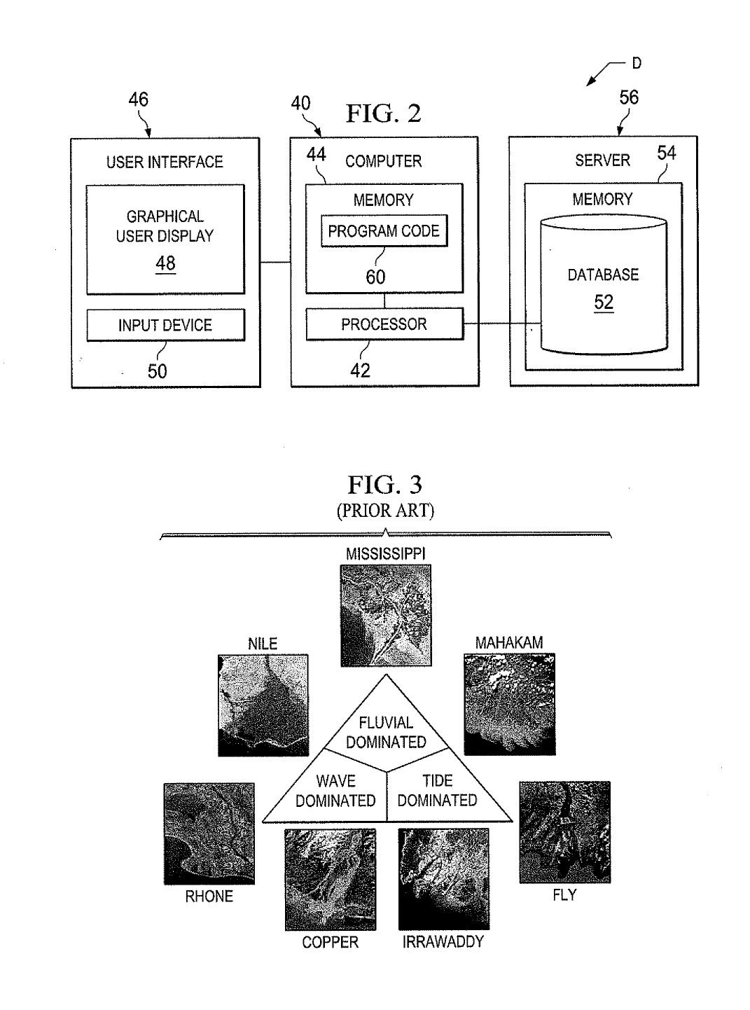

As shown in the flow chart F of FIG. 1, a preferred sequence of steps of a computer implemented method or process according to the present invention is illustrated schematically. The flow chart F is a high-level logic flowchart illustrates a method according to the present invention of forming a model indicating the relationship of rock bodies or complex objects in the earth to evaluate recoverable hydrocarbons and other geological information of interest. Proportions and cumulants are initially computed from well data and (2D) satellite images separately. The objective of the workflow (FIG. 1) is to equalize the cumulants and proportions in the satellite image to match what is observed in wells. The method of the present invention is performed in a data processing system D (FIG. 2) and implemented utilizing the computer program steps of FIG. 1.

The present invention utilizes physical measurements and images taken from an area of interest in the planet and provides measures of tensor anisotropy of heterogeneity of complex rock bodies or areas in the area of interest. The present invention determines the tensor structure of multiple orientations interactively pointed from plots made by a stereographic projection plotting methodology known as stereonet. Directions are then chosen and the cross-cumulant computations and modeling performed with cross cumulant functions, as described below. The structural relations obtained among rock bodies or complex objects go beyond classic covariances, variograms and trivial correlations. A stereonet plot enables mathematical analysis to assure that the physical spatial distribution of rocks in the vertical direction is not independent of the lateral direction. Thus the anisotropy is described by a tensor of higher-order relations rather than independent directional components. Indeed, the methodology of the present invention is available not only for predicting rocks, but for studying other anisotropic phenomena.

The present invention relates to computerized physical spatial-statistics analytical tools which are applied to sequence stratigraphy for the study of geological heterogeneity. The present invention quantitatively helps to resolve the problem of selecting a valid satellite image suitable as a parametric analog for a sedimentary depositional environment and specific well data. Process step 14 contains a data base of categorical images obtained previous classification of rock bodies performed from satellite images. A selected image is loaded which follows the recommendation from a geologist, and can be suitable for the well data loaded in process step 12.

Turning again to FIG. 1, well data as indicated at 12 are loaded, and categorical data for geobodies in the depositional environment are generated based on gamma ray derivatives, and/or cores or other measurements or descriptions of data regarding such geobodies. Geobodies are accumulations of rocks that show clear signatures of coarsening or fining upwards textural rock features in the vertical direction. Such signatures are visible in gamma ray logs that detect the content of clay minerals. Thus, the derivatives of gamma ray are a quantitative analysis of the slope of signals to classify rocks as coarsening or fining upwards rock bodies. Such classification of rocks together with a few, more expensive core descriptions helps to get abundant facies data in hundreds of wells. Abundant data are needed for a reliable construction of variogram anisotropies and cross-cumulants.

The gamma ray derivatives are used in quantifying fining and coarsening upwards textual sequences. A categorical image is also loaded simplified to contain the same rock categories as identified in the well data. Process step 14 contains a data base of categorical images obtained previous classification of rock bodies performed from satellite images. A selected image is loaded which follows the recommendation from a geologist, and can be suitable for the well data loaded in process step 12.

The satellite analogs are normally selected following initial core description and expert input. One of the purposes of this invention is to provide a quantitative validation of the selected satellite image analog through the construction of the meta-model. Process step 18, described below, provides the qualitative analyst a mathematical proof about the validity or lack of consistency of an initial suggestion (process step 22).

Satellite image-analogs are taken from the present planet surface in selected areas (e.g., classic deltas, dunes, and the like as shown in FIG. 3). However, well data are taken in ancient consolidated sediments which rest thousands of feet below the present surface, and normally in a different geographic location. The analog satellite image is not a picture of drilled rock where wells are present in a formation of interest but a picture of similar (analog) superficial visible phenomena.

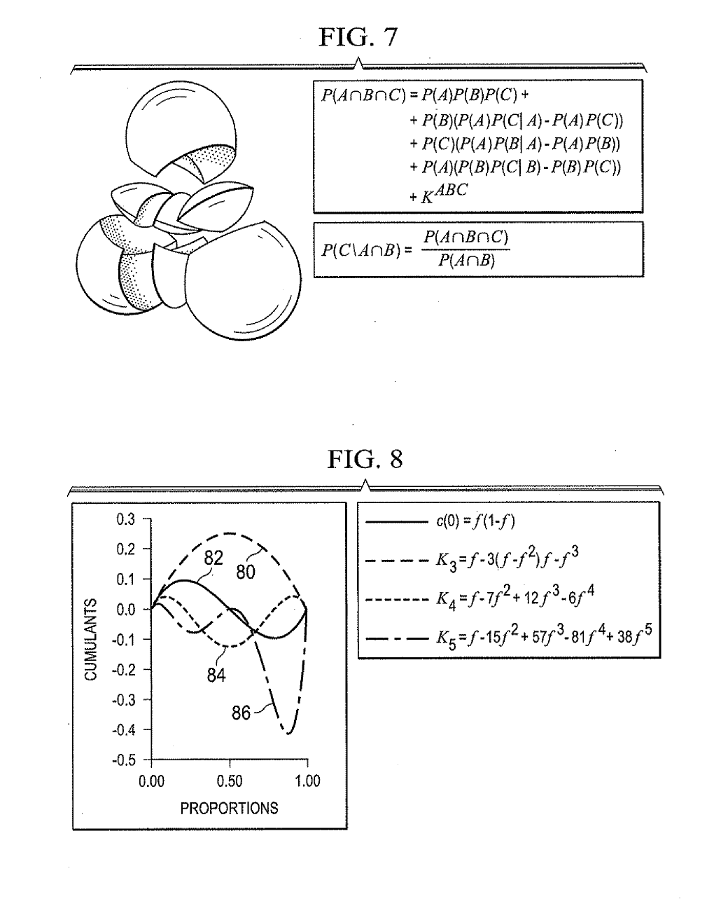

As indicated schematically at step 16, a moving window determines proportions of rock joint events of order G separated a set of lag distances G−1. Thus, for example, two lag distances are needed for third order rock joint event. The determination of properties of rock joint events is done for second to fifth order on the well data. The cumulant processing explained below in connection to probabilities represented in FIG. 7 and described below regarding Equations (1) and (13) is utilized during step 16. It should be understood, however, the number of orders can be increased or enhanced, if desired. The data processing results of step 16 are evaluated and their non-stationarity established with zonations.

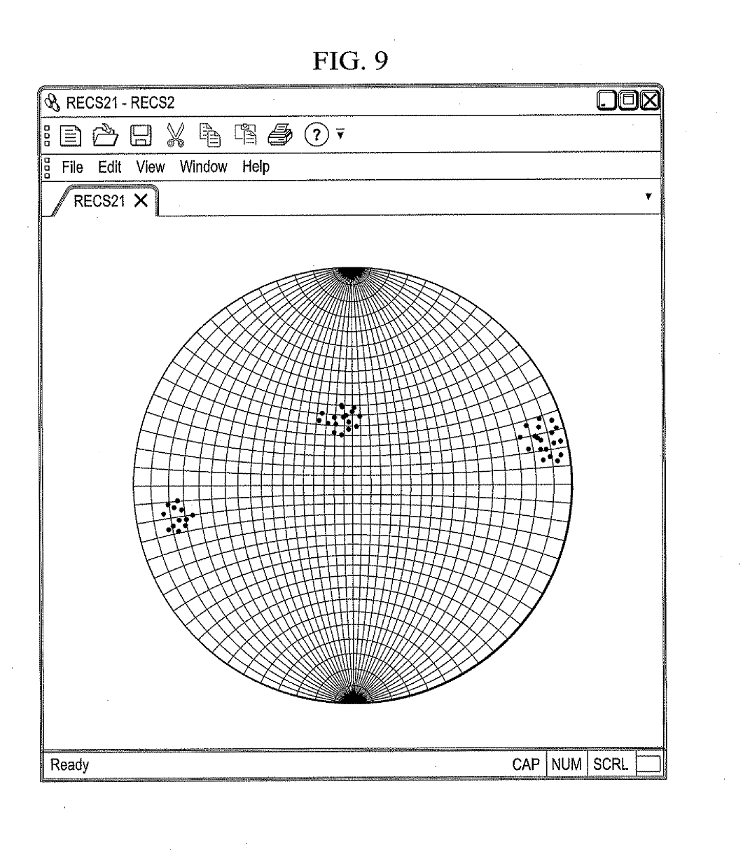

Process step 18 is performed to construct geobodies. A plotting device known as a stereonet is enabled, allowing a user/analyst to select 3D vector directions interactively. FIG. 9 is an example plot from a stereonet plotter. The stereonet plot points to a constructor of spatial tensorial relations in the image on the horizontal projections of the specified trends. The tensorial variability is constructed by selecting directions in the stereonet, and the principal directions are found by a data processing and analysis process known as independent component analysis, but using higher order cumulants, such process is performed interactively selecting direction in process step 18. The result is a display which simplifies the variability in output of structural and dimensional information about the objects in the subsurface.

The stereonet plotter used in construction of geobodies during step 18 is an interactive plotter, allowing the user to iteratively project the wells onto the image, while making a preliminary search by 360° rotations. The result of interactive projection by the stereonet plotter deforms or adjusts the scale of the well positions through the geobodies and shifts the origin of the wells to maximize the linear correlation with the wells for selected rock categories and selected sequences. Information about sequence boundaries limits the section of data which is subject to the iterative projection.

Once the wells have demonstrated to contain sequences that match the image sequences, the lateral deformation and shifting applied are projected on the vertical or well bore directions. The required deformation parameters are then interpolated to construct a deformation meta-model. The images are deformed following this deformation meta-model. Thus, a result is a 3D meta-model containing the equalized, non-linearly, deformed and phase displaced stack of categorical satellite images extracted from satellite analog.

Data points in the stereo-net represent interactively selected vector directions in 3D. Once a direction is specified by the operator the present invention computes the ranges of continuity of cross-cumulants (process step 20). With more than two directions selected, the present invention performs anisotropy analysis (process step 22), and evaluates the match between anisotropy ratios of (variogram) ranges and the anisotropy previously observed in the well data. If the match fails an expert is consulted and the proposed vector directions are modified again (process step 18). If the anisotropy ratios match within a reasonable error, an attempt is made to equalize signals from the meta-model (stacked satellite images) to the wells in the selected directions (process step 26) to match not only the anisotropy ratios but the actual variogram ranges of spatial continuity. In addition, third and higher order cumulants are used to match the facies proportions in the meta-model to those observed in the wells.

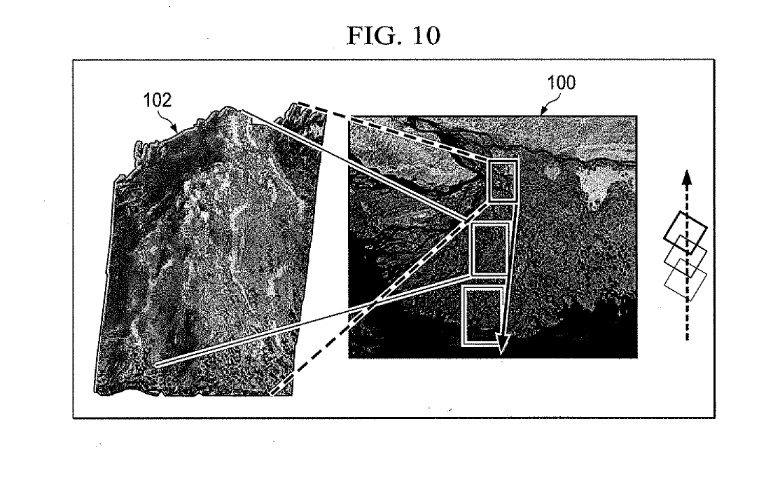

Cross structures are determined during step 20 on well data and on the image 3D meta-model. The processing during step 20 is based on a determination of the probability of multiple joint events, as described below. A cross-cumulant model is generated for every pair of indicated or expected directions and rock categories. The directions are selected based on the analysis of anisotropy performed a priori. During step 22, the directions found during step 18 and the cross-cumulant model processing of step 20 are evaluated and compared against each other. The stereonet and cross-structures detect whether an analog or image is suitable for certain well data, and a reviewing analyst/sequence stratigrapher recommends whether the analog should be rejected or accepted with in a certain probability of error as indicated at step 24. The analysis performed during step 24 further is predicated on the data images being in conformity with Walther's Law, that the vertical progressing of facies changes should be the same as corresponding lateral facies changes. If the image is accepted a proposed meta-model (FIG. 10) is part of the processing results output during step 26. FIG. 10 represents a categorized 2D image assembled over three dimensional space following Walther's law using object modeling. the actual content of the meta-model represented by the image of FIG. 10 is a numerical 3D (tridimensional) set of data stored in database memory.

The meta-models of deformation are iteratively optimized to maximize the similarity between the cross structures at well data and cross structures at the 3D image meta-model (at well and outside well bores).

Equalization of the image to the wells includes various steps. First the well data is projected on the lateral surface covered by an image. Second, the image is rotated, shifted and transformed to maximize the cross-correlation between a well and its possible lateral projections, on the image. Third a sequential kriging of indicators is performed to predict the deformed image from the projected well data, with parameters extracted from the image itself in 3D. Conditional probabilities described in detail below are utilized together with abundant bootstrapping sampling of the image. Fourth, a new well is brought into the data processing and the operation is sequentially repeated. The final result is a 3D numerical meta-model of facies from which images such as those of FIG. 10 are formed.

With the cross-structures resembling one another, a detailed evaluation of anisotropy is carried on during step 22 to find the possible direction that lead to a framework for optimized modeling by considering a second deformation meta-model due to shift from anisotropy to isotropy conditions. Anisotropies are analyzed beyond the second order. Proportions are related to cumulants (FIG. 7) and the maximum directions of continuity for each order follow the polynomial equations in FIG. 7. The overall anisotropy is a complex combination function of the proportion (i.e., probability) of joint events. In other words, data orthogonal in the second order may not be orthogonal in the third order, and so forth.

The image meta-model is analyzed as indicated at step 24 by the analyst/user based on that person's experience to suggest corrections or modifications. The accepted meta-model passes to next step, or otherwise analyst input is provided by an analyst sequence stratigrapher during step 24 and processing reverts back to the stereonet analysis according to step 18 as described above.

FIG. 10 at 100 shows a satellite image from Lena Delta (Siberia, Russia), and also shows at 102 the braided and tidal channels extracted and equalized to real well data from boreholes. The end results are stacked braided and tidal channels from distal and proximal areas of the analog shown at 102. The well data used in the analysis are facies logs computed from gamma ray derivatives from logging data, and core descriptions.

Once the meta-Models are determined to be well constructed and representative during step 22, an image meta-model is reconstructed during step 26 by projecting one well at a time on the existing image-meta model. The well data is then used to generate, with the use of computer implemented sequential kriging interpolation techniques, the conditional probabilities needed for simulation of facies at each surrounding location. Based on these predicted probabilities, the image meta-model is corrected, and the probabilities and other parameters extracted from the image meta-model are reported as indicated at step 28 and can be used for stochastic simulation of facies models and geocellular modeling. Thus, process step 28 is the actual construction of the final 3D metamodel made up of equalized stacked satellite images which should match the cumulants and proportions observed in the wells.

Vertical categorical well data is provided, and a preparation of categorical data, with derivatives of logs is also enabled. Geobodies categories at wells are computed from spatial derivatives of proportions for rock events and derivatives of gamma ray logging data. The categories obtained from such analyses are the input to the Walther's Equalizer, and can be used for object modeling, multipoint statistics or other algorithms. Any advanced modeling of spatial distribution of rocks requires the use of depositional environments that can be represented by these geobodies categories.

As illustrated in FIG. 2, a data processing system D according to the present invention includes a computer 40 having a processor 42 and memory 44 coupled to the processor 42 to obtain a measure of spatial relations in subsurface formalities. The computer 40 may, if desired, be a portable digital processor, such as a personal computer in the form of a laptop computer, notebook computer or other suitable programmed or programmable digital data processing apparatus, such as a desktop computer. It should also be understood that the computer 40 may be a multicore processor with nodes such as those from Intel Corporation or Advanced Micro Devices (AMD), or a mainframe computer of any conventional type of suitable processing capacity such as those available from International Business Machines (IBM) of Armonk, N.Y. or other source.

The computer 40 has a user interface 46 and an output display 48 for displaying output data or records of processing of well logging data measurements performed according to the present invention to obtain a measure of transmissibility of fluid in subsurface formations. The output display 48 includes components such as a printer and an output display screen capable of providing printed output information or visible displays in the form of graphs, data sheets, graphical images, data plots and the like as output records or images.

The user interface 46 of computer 40 also includes a suitable user input device or input/output control unit 50 to provide a user access to control or access information and database records and operate the computer 40. The functionality of the stereonet module used during step 18 (FIG. 1) may be performed by the user interface 46 and output display 48, if desired. Alternatively, a separate module may be provided for stereonet plotting. Data processing system D further includes a database 52 stored in computer memory, which may be internal memory 44, or an external, networked, or non-networked memory as indicated at 54 in an associated database server 56.

The data processing system D includes program code 60 stored in memory 44 of the computer 40. The program code 60, according to the present invention is in the form of computer operable instructions causing the data processor 42 to form obtain a measure of transmissibility of fluid in subsurface formations, as will be set forth.

It should be noted that program code 60 may be in the form of microcode, programs, routines, or symbolic computer operable languages (such as C++ code) that provide a specific set of ordered operations that control the functioning of the data processing system D and direct its operation. The instructions of program code 60 may be stored in memory 44 of the computer 40, or on computer diskette, magnetic tape, conventional hard disk drive, electronic read-only memory, optical storage device, or other appropriate data storage device having a computer usable medium stored thereon. Program code 60 may also be contained on a data storage device such as server 64 as a computer readable medium, as shown.

The flow chart F of FIG. 1 illustrates the structure of the logic of the present invention as embodied in computer program operating instructions. Those skilled in the art appreciate that the flow charts illustrate the structures of computer program code elements that function according to the present invention. The invention is practiced in its essential embodiment by computer components that use the program code instructions in a form that instructs the digital data processing system D to perform a sequence of processing steps corresponding to those shown in the flow chart F.

Geologists currently use the qualitative Walther's law in connection with what is known as Hutton's uniformitarism principle for making conceptual models describing vertical sequences of rocks in relation to lateral (e.g., horizontal) deposition, as observed on satellite images or analogs. The present invention provides an analytical tool based on anisotropy and transforms the theory underlying Walther's law to a quantitative imaging of the vertical and lateral successions of complex rock sequences. The present invention thus adapts Walther's law so that analysis may be quantitatively obtained regarding subterranean features utilizing spatial mathematical/probabilistic and physical principles. The relationship between lateral and vertical heterogeneity is highly complex, and requires detailed extraction of complex vector and tensor relations among non-independent directions to detect rock bodies or objects oriented in 3D space.

FIG. 3 describes a simplified classification of analog images using the well known Galloway triangle. In FIG. 3, satellite earth images of certain river deltas are shown classified based on the Galloway triangle. The Mississippi River delta is classified as fluvial dominated; the Mahakam River (Indonesia) delta is classified as between fluvial dominated and tide dominated; the Fly River (Papua New Guinea) delta is classified as tide dominated; the Irrawaddy River (Myanmar) delta is classified as primarily tide dominated; the Copper River (Alaska) delta is classified as primarily wave dominated; the Rhone River (France) delta is classified as wave dominated; and the Nile River (Egypt) delta is classified as between wave dominated and fluvial dominated. Each depositional environment contains specific characteristic facies proportions and cumulant anisotropy characteristics which should match the observed well data.

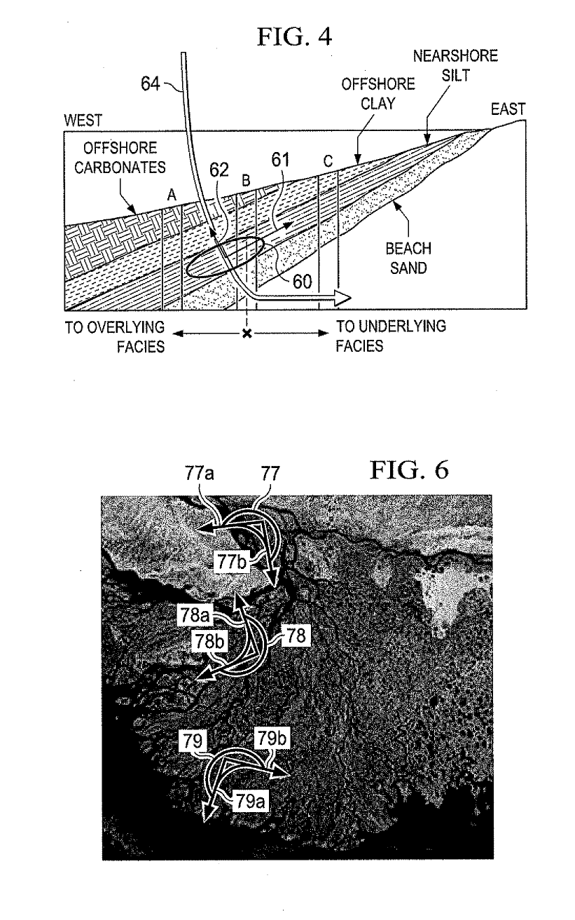

As is known, Walther's law proposes that the vertical progression of facies should be the same as the corresponding lateral facies changes. FIG. 4 is a simple illustrative generalization of Walther's law regarding a comparison to anisotropy and principal components in the context of the present invention. FIG. 4 illustrates that any direction in which a well is drilled is correlated to surrounding directions. Therefore, the sequence of rocks observed in a vertical or inclined well is a projection of the lateral sequence of rocks. However, an exception to Walther's law is when the lateral and the drilled directions coincide with principal directions of anisotropy as observed from variograms or higher-order structures (i.e., cross-cumulants). The ellipse 60 in FIG. 4 shows an example of those principal directions (lateral direction 61 and drilled direction 62) and a directional well 64.

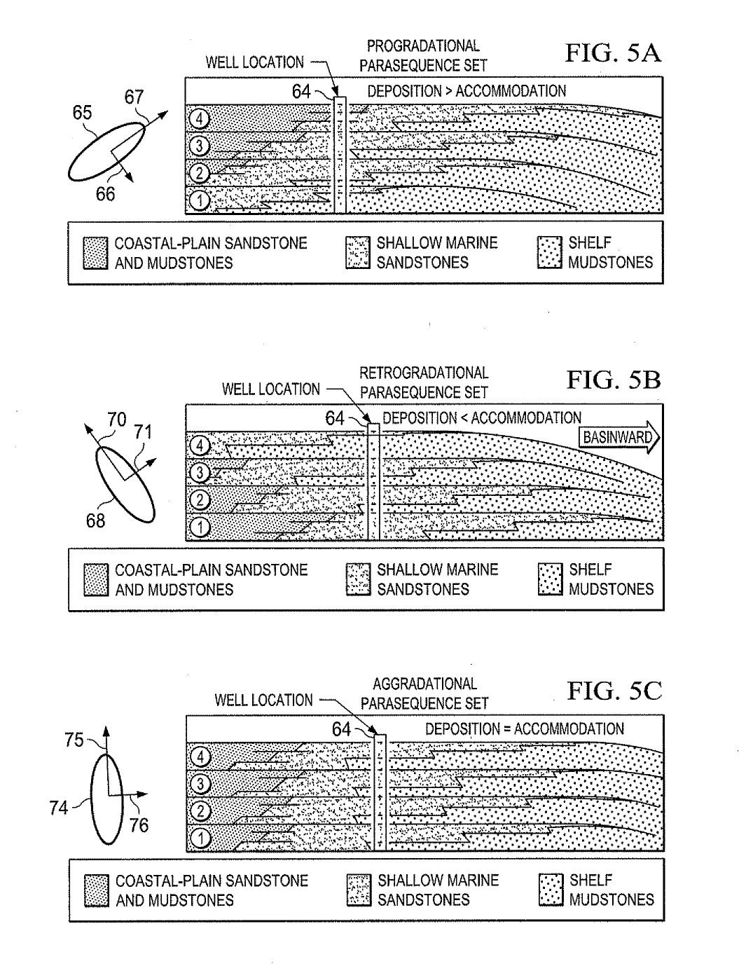

FIGS. 5A, 5B, and 5C are further similar illustrations of Walther's law from the perspective of anisotropy in the context of the present invention. FIG. 5A illustrates the sequence of rocks in a progradational sequence in the vicinity of a well 64, with an ellipse 65 showing on example of principal directions 66 and 67 of anisotropy in a progradational geological sequence. FIG. 5B illustrates, as an alternative, a retogradational sequence in the vicinity of well 64 with ellipse 68 showing an example of principal directions of anisotropy 70 and 71 in this situation. FIG. 5C illustrates, as a further alternative, an aggradational sequence in the vicinity of well 64 with an ellipse 74 showing an example of principal directions of anisotropy 75 and 76.

FIG. 6 is a display complex anisotropy in a fluvial deltaic environment with tidal components with of tensor anisotropy superimposed. In FIG. 6, superimposed on a satellite image of a river delta three locations are representations of tensor anisotropy 77, 78 and 79, each having a different pair of projected principal directions of anisotropy 77a and 77b, 78a and 78b, and 79a and 79b, respectively.

FIGS. 4, 5 through 5C, and 6 are thus demonstrations that the qualitative Walther law can be quantified as anisotropy due to rock bodies. The anisotropy is defined as the directional dependence of the range of spatial continuity of rock bodies (e.g., dunes, meandering or braided channel geometries, and the like.

The present invention computes complex and long mathematical non-linear relations between horizontal analog images and vertical information from wells. The present invention forms computer models based on physical phenomena stemming from a known qualitative geological paradigm—that vertical variability of deposited rocks can be projected onto the lateral domain of satellite images taken on present geological phenomena, as observed on the earth's surface. The present invention provides a more accurate, quantitative expression of the qualitative assessment made by Walther's law known in sequence stratigraphy. Walther's law proposes that the vertical progression of facies should be the same as the corresponding lateral facies changes.

The present invention provides a methodology which generalizes and applies the principles of Walther's law as a modeling and analytical methodology of spatial dependence. Accordingly, with the present invention two directions of possible heterogeneity of anisotropy are deemed to match each other, or have higher order correlations, when signals obtained from measurements regarding earth features are put in the same phase and wavelength scale, or what is termed according to the present invention equalized. This operation implies an empirical shift and deformation of the lateral image signal to maximize its correlation to a well. Walther's law has been related according to the present invention to anisotropy. Thus, two directions are not independent, if at least one of them does not coincide with the direction of maximum continuity, the axis of variogram anisotropy.

For curvilinear bodies (e.g., meandering and braided channels). Walther's law depends on complex curvilinear axes of anisotropy. Such a problem requires using tensors with higher order cumulants for multiple directions. This leads to non-stationary anisotropy which is a function of proportions. FIG. 8, as will be described, illustrates the relation between proportions and higher order cumulants.

With the present invention, the decomposition of moments into tensor structures allows for predictions because the proposed structures are addible, as shown in FIG. 8. The numerical example is a simplified example of the basic principles used. In more complex cases with actual data, classifying images such as deltas like those shown in FIGS. 3 and 5 with cumulants from scanned images permits quantification of the proportions of joint events.

Thus, a new concept of tensor anisotropy of facies distributions is imbedded in the subsurface directional analysis which the present invention provides. The tensor anisotropy concept is utilized to decompose the proportions in residuals for the second, third and higher order of cumulants. The spatial structures for those residuals are found and their local principal directions of anisotropy established (FIG. 6). The new anisotropy is a set of n−1 connected ellipses of continuity, for each order n. For example, systems that require (at least) a description with cumulants of order three (n−3) show two (2=3−1) connected ellipses of anisotropy.

As has been described, FIG. 3 is an illustration of the traditional classification of deltaic systems. A description of this classification is discussed in Galloway, W. E., and Hobday, D. K., “Terrigenous clastic depositional systems”, Springer, Berlin, 1996. While the actual classification is related to the depositional dynamics, one could attempt to quantify the frequency of joint events in a selected pattern. The initial approach may be to count the proportion of joint events for a given distance from the sea, or in a vertical sequence. The proportion or joint probability is usually abbreviated with the intersection of individual events {A, B, C, D . . . n}, then the probability is P(A∩B∩C∩D . . . ∩N). Assume the joint events give proportions of geo-bodies occurring due to (a) tidal, (b) fluvial, and (c) wave dynamics. Therefore, the joint probability and complex anisotropy analysis are analogous but precise to locate a delta in the Galloway triangle.

### The Kappa Model for the Probability of Joint Events

The computation of joint proportions for events or rock bodies in the analogs of FIG. 3 is a probability of a joint multiple event. One can propose to decompose such complex joint probability with a novel approach termed Kappa model, and for three events this is

$$P ( A ⋂ B ⋂ C ) = P ( A ) P ( B ) P ( C ) ++ P ( B ) ( P ( A ) P ( C \vert A ) - P ( A ) P ( C ) ) + P ( C ) ( P ( A ) P ( B \vert A ) - P ( A ) P ( B ) ) + P ( A ) ( P ( B ) P ( C \vert B ) - P ( B ) P ( C ) ) + {κ}^{ABC} . \qquad ( 1 )$$

Where the first row is the product of the probability (i.e., proportions) for independent events. This product is not informative about any pattern. The second to fourth rows are the effect due to pair-wise (Markovian) transition probabilities. For example, they may describe joint events on the sides of the Galloway triangle. The last kappa (cumulant) term is due to the true triple relation between events, and it is the only measure of the three events happening in a joint pattern. Equation 1 is a novel way to compute the probability of having any combination of events at any scale, indeed.

Therefore, tensor relations are proposed to be used for detailed sequence stratigraphy studies and object or multipoint modeling constraints. The transition probabilities in a sequence are related to the pair-wise conditional probabilities P(A|B), P(C|B), P(C|A). The conditional probability of higher order (i.e., third order, FIG. 3) has been resolved here by extending the Bayesian conditioning, this is

$$P ( C \vert ( A ⋂ B ) ) = \frac{P ( A ⋂ B ⋂ C )}{P ( A ⋂ B )} \qquad ( 2 )$$

Rock bodies control the transition probabilities of rocks assembled in sequences; therefore Equation 2 can be used to quantify the vertical and lateral successions of complex rock sequences observed in core description. Results obtained by sedimentologists may provide average proportions of patterns with an astounding similarity to what can be encountered in satellite images.

### A Numerical Example of Higher Order Conditional Probability

In applying the present invention, a determination is made of proportions and probabilities for joint rock-body events. A short numerical example (Tables 1 to 3) illustrates this. In Tables 1 to 3, the proportion of joint events can be seen to implicate a count of how many times a triple or multiple point event occurs in a sequence. Predicting these joint probabilities has, so far as is known, been impossible in the past because handling higher moments is non-trivial and extremely complex. So far as is known, the use of cumulants for this purpose has not been previously recognized or attempted.

In this example, the principles of computing probability of joint events in rock sequences are outlined. Table 1 is a detailed set of outcomes for rock categories in a rock sequence.

TABLE 1
A Sequence of Three Rocks: Sandstone, Siltstone, Shale

| | | | | AB | BC | AC | ABC | AB | BC | AC | ABC |
|---|---|---|---|---|---|---|---|---|---|---|---|
| 1 | [symbol] | 0 | 0 | 1 | 1 | 1 | 1 | [symbol] | 0 | 0 | 0 |
| 2 | 0 | 1 | 0 | 0 | 0 | 0 | 0 | [symbol] | 0 | 0 | 0 |
| 3 | 0 | 0 | 1 | 0 | 0 | 0 | 0 | [symbol] | 0 | 0 | 0 |
| 4 | 0 | 0 | 1 | 0 | 0 | 0 | 0 | [symbol] | 0 | 0 | 0 |
| 5 | 0 | 1 | 0 | 0 | 0 | 0 | 0 | [symbol] | 0 | 0 | 0 |
| 6 | [symbol] | 0 | 0 | 0 | 0 | 0 | 0 | [symbol] | 1 | 1 | 1 |
| 7 | [symbol] | 0 | 0 | 1 | 1 | 1 | 1 | [symbol] | 0 | 0 | 0 |
| 8 | 0 | 1 | 0 | 0 | 0 | 0 | 0 | [symbol] | 0 | 0 | 0 |
| 9 | 0 | 0 | 1 | 0 | 0 | 0 | 0 | [symbol] | 0 | 0 | 0 |
| 10 | [symbol] | 0 | 0 | 0 | 0 | 0 | 0 | [symbol] | 0 | 0 | 0 |
| 11 | 0 | 0 | 1 | 0 | 0 | 0 | 0 | [symbol] | 0 | 0 | 0 |
| 12 | 0 | 1 | 0 | 0 | 0 | 0 | 0 | [symbol] | 0 | 0 | 0 |
| 13 | [symbol] | 0 | 0 | 1 | 1 | 1 | 1 | [symbol] | 1 | 1 | 1 |
| 14 | 0 | 1 | 0 | 0 | 0 | 0 | 0 | [symbol] | 0 | 0 | 0 |
| 15 | 0 | 0 | 1 | 0 | 0 | 0 | 0 | [symbol] | 0 | 0 | 0 |
| 16 | [symbol] | 0 | 0 | 1 | 1 | 1 | 1 | [symbol] | 0 | 0 | 0 |
| 17 | 0 | 1 | 0 | 0 | 0 | 0 | 0 | [symbol] | 0 | 0 | 0 |
| 18 | 0 | 0 | 1 | 0 | 0 | 0 | 0 | [symbol] | 0 | 0 | 0 |
| 19 | [symbol] | 0 | 0 | 1 | 1 | 1 | 1 | [symbol] | 0 | 0 | 0 |
| 20 | 0 | 1 | 0 | 0 | 0 | 0 | 0 | [symbol] | 0 | 0 | 0 |
| 21 | 0 | 0 | 1 | 0 | 0 | 0 | 0 | [symbol] | 0 | 0 | 0 |
| 22 | [symbol] | 0 | 0 | 1 | 1 | 1 | 1 | [symbol] | 0 | 0 | 0 |
| 23 | 0 | 1 | 0 | 0 | 0 | 0 | 0 | [symbol] | 0 | 0 | 0 |
| 24 | 0 | 0 | 1 | 0 | 0 | 0 | 0 | [symbol] | 0 | 0 | 0 |
| 25 | [symbol] | 0 | 0 | 1 | 1 | 1 | 1 | [symbol] | 0 | 0 | 0 |
| 26 | 0 | 1 | 0 | 0 | 0 | 0 | 0 | [symbol] | 0 | 0 | 0 |
| 27 | 0 | 0 | 1 | 0 | 0 | 0 | 0 | [symbol] | 0 | 0 | 0 |
| 28 | [symbol] | 0 | 0 | 1 | 1 | 1 | 1 | [symbol] | 0 | 0 | 0 |
| 29 | 0 | 1 | 0 | 0 | 0 | 0 | 0 | [symbol] | 0 | 0 | 0 |
| 30 | 0 | 0 | 1 | 0 | 0 | 0 | 0 | [symbol] | 0 | 0 | 0 |
| 31 | [symbol] | 0 | 0 | 0 | 0 | 0 | 0 | [symbol] | 0 | 0 | 0 |
| 32 | [symbol] | 0 | 0 | 1 | 0 | 0 | 0 | [symbol] | 0 | 1 | 0 |
| 33 | 0 | 1 | 0 | 0 | 0 | 0 | 0 | [symbol] | 0 | 0 | 0 |
| 34 | [symbol] | 0 | 0 | 0 | 0 | 0 | 0 | [symbol] | 0 | 0 | 0 |
| 35 | 0 | 0 | 1 | 0 | 0 | 0 | 0 | [symbol] | 0 | 0 | 0 |
| 36 | [symbol] | 0 | 0 | 1 | 0 | 0 | 0 | [symbol] | 0 | 0 | 0 |
| 37 | 0 | 1 | 0 | 0 | 0 | 0 | 0 | [symbol] | 0 | 0 | 0 |
| 38 | [symbol] | 0 | 0 | 1 | 1 | 1 | 1 | [symbol] | 0 | 0 | 0 |
| 39 | 0 | 1 | 0 | 0 | 0 | 0 | 0 | [symbol] | 0 | 0 | 0 |
| 40 | 0 | 0 | 1 | 0 | 0 | 0 | 0 | [symbol] | 0 | 0 | 0 |
| 41 | [symbol] | 0 | 0 | 0 | 0 | 0 | 0 | [symbol] | 0 | 0 | 0 |
| 42 | 0 | 0 | 1 | 0 | 0 | 0 | 0 | [symbol] | 0 | 0 | 0 |
| 43 | 0 | 1 | 0 | 0 | 0 | 0 | 0 | [symbol] | 0 | 0 | 0 |
| 44 | [symbol] | 0 | 0 | 1 | 0 | 0 | 0 | [symbol] | 1 | 1 | 1 |
| 45 | 0 | 1 | 0 | 0 | 0 | 0 | 0 | [symbol] | 0 | 0 | 0 |
| 46 | [symbol] | 0 | 0 | 1 | 0 | 0 | 0 | [symbol] | 0 | 0 | 0 |
| 47 | 0 | 1 | 0 | 0 | 0 | 0 | 0 | [symbol] | 0 | 0 | 0 |
| 48 | 0 | 1 | 0 | 0 | 0 | 0 | 0 | [symbol] | 0 | 0 | 0 |
| 49 | [symbol] | 0 | 0 | 1 | 0 | 0 | 0 | [symbol] | 0 | 0 | 0 |
| 50 | 0 | 1 | 0 | 0 | 0 | 0 | 0 | [symbol] | 0 | 0 | 0 |
| 51 | 0 | 1 | 0 | 0 | 0 | 0 | 0 | [symbol] | 0 | 0 | 0 |
| 52 | [symbol] | 0 | 0 | 1 | 0 | 0 | 0 | [symbol] | 0 | 0 | 0 |
| 53 | 0 | 1 | 0 | 0 | 0 | 0 | 0 | [symbol] | 0 | 0 | 0 |
| 54 | [symbol] | 0 | 0 | 0 | 0 | 0 | 0 | [symbol] | 0 | 0 | 0 |
| 55 | [symbol] | 0 | 0 | 1 | 0 | 0 | 0 | [symbol] | 0 | 0 | 0 |
| 56 | 0 | 1 | 0 | 0 | 0 | 0 | 0 | [symbol] | 0 | 0 | 0 |
| 57 | [symbol] | 0 | 0 | 0 | 0 | 0 | 0 | [symbol] | 0 | 0 | 0 |
| 58 | [symbol] | 0 | 0 | 1 | 1 | 1 | 1 | [symbol] | 0 | 0 | 0 |
| 59 | 0 | 1 | 0 | 0 | 0 | 0 | 0 | [symbol] | 0 | 0 | 0 |
| 60 | 0 | 0 | 1 | 0 | 0 | 0 | 0 | [symbol] | 0 | 0 | 0 |
| 61 | [symbol] | 0 | 0 | 1 | 0 | 0 | 0 | [symbol] | 0 | 0 | 0 |
| 62 | 0 | 1 | 0 | 0 | 0 | 0 | 0 | [symbol] | 0 | 0 | 0 |
| 63 | [symbol] | 0 | 0 | 0 | 0 | 1 | 0 | [symbol] | 0 | 0 | 0 |
| 64 | [symbol] | 0 | 0 | 0 | 0 | 0 | 0 | [symbol] | 0 | 0 | 0 |
| 65 | 0 | 0 | 1 | 0 | 0 | 0 | 0 | [symbol] | 0 | 0 | 0 |
| 66 | 0 | 1 | 0 | 0 | 0 | 0 | 0 | [symbol] | 0 | 0 | 0 |
| 67 | [symbol] | 0 | 0 | 1 | 1 | 1 | 1 | [symbol] | 1 | 1 | 1 |
| 68 | 0 | 1 | 0 | 0 | 0 | 0 | 0 | [symbol] | 0 | 0 | 0 |
| 69 | 0 | 0 | 1 | 0 | 0 | 0 | 0 | [symbol] | 0 | 0 | 0 |
| 70 | [symbol] | 0 | 0 | 1 | 1 | 1 | 1 | [symbol] | 0 | 0 | 0 |
| 71 | 0 | 1 | 0 | 0 | 0 | 0 | 0 | [symbol] | 0 | 0 | 0 |
| 72 | 0 | 0 | 1 | 0 | 0 | 0 | 0 | [symbol] | 0 | 0 | 0 |
| 73 | 0 | 1 | 0 | 0 | 0 | 0 | 0 | [symbol] | 0 | 0 | 0 |
| 74 | [symbol] | 0 | 0 | 0 | 0 | 0 | 0 | [symbol] | 1 | 1 | 1 |
| 75 | 0 | 0 | 1 | 0 | 0 | 0 | 0 | [symbol] | 0 | 0 | 0 |
| 76 | 0 | 1 | 0 | 0 | 0 | [symbol] | 0 | 0 | 0 | 0 | 0 |
| 77 | [symbol] | 0 | 0 | 1 | 1 | [symbol] | 1 | 1 | 1 | 1 | 1 |
| 78 | 0 | 1 | 0 | 0 | 0 | [symbol] | 0 | 0 | 0 | 0 | 0 |
| 79 | 0 | 0 | 1 | 0 | 0 | [symbol] | 0 | 0 | 0 | 0 | 0 |
| 80 | [symbol] | 0 | 0 | 1 | 1 | [symbol] | 1 | 0 | 0 | 0 | 0 |
| 81 | 0 | 1 | 0 | 0 | 0 | [symbol] | 0 | 0 | 0 | 0 | 0 |
| 82 | 0 | 0 | 1 | 0 | 0 | [symbol] | 0 | 0 | 0 | 0 | 0 |
| 83 | [symbol] | 0 | 0 | 1 | 1 | [symbol] | 1 | 0 | 0 | 0 | 0 |
| 84 | 0 | 1 | 0 | 0 | 0 | [symbol] | 0 | 0 | 0 | 0 | 0 |
| 85 | 0 | 0 | 1 | 0 | 0 | [symbol] | 0 | 0 | 0 | 0 | 0 |
| 86 | [symbol] | 0 | 0 | 1 | 0 | [symbol] | 0 | 0 | 0 | 0 | 0 |
| 87 | 0 | 1 | 0 | 0 | 1 | [symbol] | 0 | 0 | 0 | 0 | 0 |
| 88 | 0 | 1 | 0 | 0 | 0 | [symbol] | 0 | 0 | 0 | 0 | 0 |
| 89 | 0 | 0 | 1 | 0 | 0 | [symbol] | 0 | 0 | 0 | 0 | 0 |
| 90 | [symbol] | 0 | 0 | 1 | 1 | [symbol] | 1 | 0 | 0 | 0 | 0 |
| 91 | 0 | 1 | 0 | 0 | 0 | [symbol] | 0 | 0 | 0 | 0 | 0 |
| 92 | 0 | 0 | 1 | 0 | 0 | [symbol] | 0 | 0 | 0 | 0 | 0 |
| 93 | 0 | 1 | 0 | 0 | 0 | [symbol] | 0 | 0 | 0 | 0 | 0 |
| 94 | [symbol] | 0 | 0 | 1 | 1 | [symbol] | 1 | 1 | 1 | 1 | 1 |
| 95 | 0 | 1 | 0 | 0 | 0 | [symbol] | 0 | 0 | 0 | 0 | 0 |
| 96 | 0 | 0 | 1 | 0 | 0 | [symbol] | 0 | 0 | 0 | 0 | 0 |
| 97 | [symbol] | 0 | 0 | 1 | 0 | [symbol] | 0 | 0 | 0 | 0 | 0 |
| 98 | 0 | 1 | 0 | 0 | 1 | [symbol] | 0 | 0 | 0 | 0 | 0 |
| 99 | 0 | 1 | 0 | 0 | 0 | [symbol] | 0 | 0 | 0 | 0 | 0 |
| 100 | 0 | 0 | 1 | 0 | 0 | [symbol] | 0 | 0 | 0 | 0 | 0 |
| 101 | [symbol] | 0 | 0 | 1 | 0 | [symbol] | 0 | 0 | 0 | 0 | 0 |
| 102 | 0 | 1 | 0 | 0 | 0 | [symbol] | 0 | 0 | 0 | 0 | 0 |
| 103 | [symbol] | 0 | 0 | 1 | 1 | [symbol] | 1 | 1 | 0 | 0 | 0 |
| 104 | 0 | 1 | 0 | 0 | 0 | [symbol] | 0 | 0 | 0 | 0 | 0 |
| 105 | 0 | 0 | 1 | 0 | 0 | [symbol] | 0 | 0 | 0 | 0 | 0 |
| 106 | 0 | 1 | 0 | 0 | 0 | [symbol] | 0 | 0 | 0 | 0 | 0 |
| 107 | [symbol] | 0 | 0 | 0 | 0 | [symbol] | 0 | 1 | 1 | 1 | 1 |
| 108 | [symbol] | 0 | 0 | 1 | 1 | [symbol] | 1 | 0 | 0 | 0 | 0 |
| 109 | 0 | 1 | 0 | 0 | 0 | [symbol] | 0 | 0 | 0 | 0 | 0 |
| 110 | 0 | 0 | 1 | 0 | 0 | [symbol] | 0 | 0 | 0 | 0 | 0 |
| 111 | [symbol] | 0 | 0 | 0 | 0 | [symbol] | 0 | 0 | 0 | 0 | 0 |
| 112 | [symbol] | 0 | 0 | 0 | 0 | [symbol] | 0 | 0 | 0 | 1 | 0 |
| 113 | 0 | 0 | 1 | 0 | 0 | [symbol] | 0 | 0 | 0 | 0 | 0 |
| 114 | 0 | 1 | 0 | 0 | 0 | [symbol] | 0 | 0 | 0 | 0 | 0 |
| 115 | [symbol] | 0 | 0 | 0 | 0 | [symbol] | 0 | 1 | 1 | 1 | 1 |
| 116 | 0 | 0 | 1 | 0 | 0 | [symbol] | 0 | 0 | 0 | 0 | 0 |
| 117 | 0 | 1 | 0 | 0 | 0 | [symbol] | 0 | 0 | 0 | 0 | 0 |
| 118 | [symbol] | 0 | 0 | 0 | 0 | [symbol] | 0 | 1 | 1 | 1 | 1 |
| 119 | [symbol] | 0 | 0 | 1 | 1 | [symbol] | 1 | 0 | 0 | 0 | 0 |
| 120 | 0 | 1 | 0 | 0 | 0 | [symbol] | 0 | 0 | 0 | 0 | 0 |
| 121 | 0 | 0 | 1 | 0 | 0 | [symbol] | 0 | 0 | 0 | 0 | 0 |
| 122 | [symbol] | 0 | 0 | 1 | 0 | [symbol] | 0 | 0 | 0 | 0 | 0 |
| 123 | 0 | 1 | 0 | 0 | 0 | [symbol] | 0 | 0 | 0 | 0 | 0 |
| 124 | [symbol] | 0 | 0 | 0 | 0 | [symbol] | 0 | 1 | 0 | 0 | 0 |
| 125 | [symbol] | 0 | 0 | 1 | 1 | [symbol] | 1 | 0 | 0 | 0 | 0 |
| 126 | 0 | 1 | 0 | 0 | 0 | [symbol] | 0 | 0 | 0 | 0 | 0 |
| 127 | 0 | 0 | 1 | 0 | 0 | [symbol] | 0 | 0 | 0 | 0 | 0 |
| 128 | [symbol] | 0 | 0 | 0 | 0 | [symbol] | 0 | 0 | 0 | 0 | 0 |
| 129 | 0 | 1 | 0 | 0 | 0 | [symbol] | 0 | 0 | 0 | 0 | 0 |
| 130 | [symbol] | 0 | 0 | 0 | 0 | [symbol] | 0 | 1 | 0 | 0 | 0 |
| 131 | [symbol] | 0 | 0 | 1 | 1 | [symbol] | 1 | 0 | 0 | 0 | 0 |
| 132 | 0 | 1 | 0 | 0 | 0 | [symbol] | 0 | 0 | 0 | 0 | 0 |
| 133 | 0 | 0 | 1 | 0 | 0 | [symbol] | 0 | 0 | 0 | 0 | 0 |
| 134 | [symbol] | 0 | 0 | 1 | 0 | [symbol] | 0 | 0 | 0 | 0 | 0 |
| 135 | 0 | 1 | 0 | 0 | 0 | [symbol] | 0 | 0 | 0 | 0 | 0 |
| 136 | [symbol] | 0 | 0 | 0 | 0 | [symbol] | 0 | 1 | 0 | 0 | 0 |
| 137 | 0 | 0 | 1 | 0 | 0 | [symbol] | 0 | 0 | 0 | 0 | 0 |
| 138 | [symbol] | 0 | 0 | 0 | 0 | [symbol] | 0 | 0 | 0 | 0 | 0 |
| 139 | 0 | 0 | 1 | 0 | 0 | [symbol] | 0 | 0 | 0 | 0 | 0 |
| 140 | [symbol] | 0 | 0 | 1 | 1 | [symbol] | 1 | 0 | 0 | 0 | 0 |
| 141 | 0 | 1 | 0 | 0 | 0 | [symbol] | 0 | 0 | 0 | 0 | 0 |
| 142 | 0 | 0 | 1 | 0 | 0 | [symbol] | 0 | 0 | 0 | 0 | 0 |
| 143 | [symbol] | 0 | 0 | 0 | 0 | [symbol] | 0 | 0 | 0 | 0 | 0 |
| 144 | 0 | 0 | 1 | 0 | 0 | [symbol] | 0 | 0 | 0 | 0 | 0 |
| 145 | 0 | 1 | 0 | 0 | 0 | [symbol] | 0 | 0 | 0 | 0 | 0 |
| 146 | [symbol] | 0 | 0 | 0 | 0 | [symbol] | 0 | 1 | 1 | 1 | 1 |
| 147 | 0 | 0 | 1 | 0 | 0 | [symbol] | 0 | 0 | 0 | 0 | 0 |
| 148 | 0 | 1 | 0 | 0 | 0 | [symbol] | 0 | 0 | 0 | 0 | 0 |
| 149 | [symbol] | 0 | 0 | 1 | 1 | [symbol] | 1 | 1 | 1 | 1 | 1 |
| 150 | 0 | 1 | 0 | 0 | 0 | [symbol] | 0 | 0 | 0 | 0 | 0 |
| 151 | 0 | 0 | 1 | 0 | 0 | 0 | 0 | 0 | 0 | 0 | 0 |
| 152 | 1 | 0 | 0 | 0 | 0 | 0 | 0 | 0 | 0 | 0 | 0 |
| 153 | 0 | 1 | 0 | 0 | 0 | 0 | 0 | 0 | 0 | 0 | 0 |
| 154 | 1 | 0 | 0 | 1 | 1 | 1 | 1 | 1 | 0 | 0 | 0 |
| 155 | 0 | 1 | 0 | 0 | 0 | 0 | 0 | 0 | 0 | 0 | 0 |
| 156 | 0 | 0 | 1 | 0 | 0 | 0 | 0 | 0 | 0 | 0 | 0 |
| 157 | 1 | 0 | 0 | 0 | 0 | 0 | 0 | 0 | 0 | 0 | 0 |
| 158 | 1 | 0 | 0 | 1 | 1 | 1 | 1 | 0 | 0 | 1 | 0 |
| 159 | 0 | 1 | 0 | 0 | 0 | 0 | 0 | 0 | 0 | 0 | 0 |
| 160 | 0 | 0 | 1 | 0 | 0 | 0 | 0 | 0 | 0 | 0 | 0 |
| 161 | 1 | 0 | 0 | 0 | 0 | 0 | 0 | 0 | 0 | 0 | 0 |
| 162 | 0 | 0 | 1 | 0 | 0 | 0 | 0 | 0 | 0 | 0 | 0 |
| 163 | 0 | 1 | 0 | 0 | 0 | 0 | 0 | 0 | 0 | 0 | 0 |
| 164 | 1 | 0 | 0 | 0 | 0 | 0 | 0 | 1 | 1 | 1 | 1 |
| 165 | 1 | 0 | 0 | 1 | 1 | 1 | 1 | 0 | 0 | 0 | 0 |
| 166 | 0 | 1 | 0 | 0 | 0 | 0 | 0 | 0 | 0 | 0 | 0 |
| 167 | 0 | 0 | 1 | 0 | 0 | 0 | 0 | 0 | 0 | 0 | 0 |
| 168 | 1 | 0 | 0 | 1 | 0 | 0 | 0 | 0 | 0 | 0 | 0 |
| 169 | 0 | 1 | 0 | 0 | 0 | 0 | 0 | 0 | 0 | 0 | 0 |
| 170 | 1 | 0 | 0 | 0 | 0 | 1 | 0 | 1 | 0 | 0 | 0 |
| 171 | 1 | 0 | 0 | 0 | 0 | 0 | 0 | 0 | 0 | 0 | 0 |
| 172 | 0 | 0 | 1 | 0 | 0 | 0 | 0 | 0 | 0 | 0 | 0 |
| 173 | 0 | 0 | 1 | 0 | 0 | 0 | 0 | 0 | 0 | 0 | 0 |
| 174 | 0 | 1 | 0 | 0 | 0 | 0 | 0 | 0 | 0 | 0 | 0 |
| 175 | 1 | 0 | 0 | 1 | 1 | 1 | 1 | 1 | 1 | 1 | 1 |
| 176 | 0 | 1 | 0 | 0 | 0 | 0 | 0 | 0 | 0 | 0 | 0 |
| 177 | 0 | 0 | 1 | 0 | 0 | 0 | 0 | 0 | 0 | 0 | 0 |
| 178 | 1 | 0 | 0 | 0 | 0 | 0 | 0 | 0 | 0 | 0 | 0 |
| 179 | 0 | 0 | 1 | 0 | 0 | 0 | 0 | 0 | 0 | 0 | 0 |
| 180 | 0 | 1 | 0 | 0 | 0 | 0 | 0 | 0 | 0 | 0 | 0 |
| 181 | 1 | 0 | 0 | 0 | 0 | 0 | 0 | 0 | 0 | 0 | 0 |
| 182 | 1 | 0 | 0 | 1 | 1 | 1 | 1 | 0 | 0 | 0 | 0 |
| 183 | 0 | 1 | 0 | 0 | 0 | 0 | 0 | 0 | 0 | 0 | 0 |
| 184 | 0 | 0 | 1 | 0 | 0 | 0 | 0 | 0 | 0 | 0 | 0 |
| 185 | 1 | 0 | 0 | 1 | 1 | 1 | 1 | 0 | 0 | 0 | 0 |
| 186 | 0 | 1 | 0 | 0 | 0 | 0 | 0 | 0 | 0 | 0 | 0 |
| 187 | 0 | 0 | 1 | 0 | 0 | 0 | 0 | 0 | 0 | 0 | 0 |
| 188 | 0 | 0 | 1 | 0 | 0 | 0 | 0 | 0 | 0 | 0 | 0 |
| 189 | 0 | 0 | 1 | 0 | 0 | 0 | 0 | 0 | 0 | 0 | 0 |
| 190 | 0 | 1 | 0 | 0 | 0 | 0 | 0 | 0 | 0 | 0 | 0 |
| 191 | 1 | 0 | 0 | 0 | 0 | 0 | 0 | 1 | 1 | 1 | 1 |
| 192 | 0 | 1 | 0 | 0 | 0 | 0 | 0 | 0 | 0 | 0 | 0 |
| 193 | 1 | 0 | 0 | 0 | 0 | 0 | 0 | 0 | 0 | 0 | 0 |
| 194 | 1 | 0 | 0 | 1 | 1 | 1 | 1 | 0 | 0 | 0 | 0 |
| 195 | 0 | 1 | 0 | 0 | 0 | 0 | 0 | 0 | 0 | 0 | 0 |
| 196 | 0 | 0 | 1 | 0 | 0 | 0 | 0 | 0 | 0 | 0 | 0 |
| 197 | 1 | 0 | 0 | 1 | 0 | 0 | 0 | 0 | 0 | 0 | 0 |
| 198 | 0 | 1 | 0 | 0 | 0 | 0 | 0 | 0 | 0 | 0 | 0 |
| 199 | 1 | 0 | 0 | 1 | 1 | 1 | 1 | 1 | 0 | 0 | 0 |
| 200 | 0 | 1 | 0 | 0 | 0 | 0 | 0 | 0 | 0 | 0 | 0 |
| 201 | 0 | 0 | 1 | 0 | 0 | 0 | 0 | 0 | 0 | 0 | 0 |
| 202 | 1 | 0 | 0 | 1 | 0 | 0 | 0 | 0 | 0 | 0 | 0 |
| 203 | 0 | 1 | 0 | 0 | 0 | 0 | 0 | 0 | 0 | 0 | 0 |
| 204 | 1 | 0 | 0 | 1 | 1 | 1 | 1 | 1 | 0 | 0 | 0 |
| 205 | 0 | 1 | 0 | 0 | 0 | 0 | 0 | 0 | 0 | 0 | 0 |
| 206 | 0 | 0 | 1 | 0 | 0 | 0 | 0 | 0 | 0 | 0 | 0 |
| 207 | 1 | 0 | 0 | 0 | 0 | 0 | 0 | 0 | 0 | 0 | 0 |
| 208 | 0 | 0 | 1 | 0 | 0 | 0 | 0 | 0 | 0 | 0 | 0 |
| 209 | 0 | 1 | 0 | 0 | 0 | 0 | 0 | 0 | 0 | 0 | 0 |
| 210 | 1 | 0 | 0 | 1 | 1 | 1 | 1 | 1 | 1 | 1 | 1 |
| 211 | 0 | 1 | 0 | 0 | 0 | 0 | 0 | 0 | 0 | 0 | 0 |
| 212 | 0 | 0 | 1 | 0 | 0 | 0 | 0 | 0 | 0 | 0 | 0 |
| 213 | 1 | 0 | 0 | 1 | 1 | 1 | 1 | 0 | 0 | 0 | 0 |
| 214 | 0 | 1 | 0 | 0 | 0 | 0 | 0 | 0 | 0 | 0 | 0 |
| 215 | 0 | 0 | 1 | 0 | 0 | 0 | 0 | 0 | 0 | 0 | 0 |
| 216 | 1 | 0 | 0 | 1 | 1 | 1 | 1 | 0 | 0 | 0 | 0 |
| 217 | 0 | 1 | 0 | 0 | 0 | 0 | 0 | 0 | 0 | 0 | 0 |
| 218 | 0 | 0 | 1 | 0 | 0 | 0 | 0 | 0 | 0 | 0 | 0 |
| 219 | 1 | 0 | 0 | 1 | 1 | 1 | 1 | 0 | 0 | 0 | 0 |
| 220 | 0 | 1 | 0 | 0 | 0 | 0 | 0 | 0 | 0 | 0 | 0 |
| 221 | 0 | 0 | 1 | 0 | 1 | 0 | 0 | 0 | 0 | 0 | 0 |
| 222 | 0 | 1 | 0 | 0 | 0 | 0 | 0 | 0 | 0 | 0 | 0 |
| 223 | 0 | 0 | 1 | 0 | 0 | 0 | 0 | 0 | 1 | 0 | 0 |
| 224 | 0 | 0 | 1 | 0 | 0 | 0 | 0 | 0 | 0 | 0 | 0 |
| 225 | 0 | 1 | 0 | 0 | 0 | 0 | 0 | 0 | 0 | 0 | 0 |

[symbol]

indicates data missing or illegible when filed

The first three columns are indicator variables representing the value (1) every time a rock occurs. The first indicator is sandstone, the second is siltstone, and the third is shale. A coarsening upward sequence (CUS) is when the triple event shale-siltstone-sandstone happens in a vertical succession going from base to top. A fining upward sequence (FUS) is when the triple event from base to top is sandstone-siltstone-shale. Table 1 also shows the indicators for joint events (AB), (BC), (AC) and (ABC) separately for both the CUS and FUS.

Tables 2.1 and 2.2 give the averages of the indicator products (or moments) for the CUS and the FUS, respectively.

TABLE 2.1
Joint Event Proportions CUS

| | A | B | C | AB | BC | AC | ABC |
|---|---|---|---|---|---|---|---|
| OCURRENCES | 86 | 79 | 60 | 56 | 39 | 41 | 36 |
| MOMENTS | 0.382 | 0.351 | 0.267 | 0.249 | 0.173 | 0.182 | 0.160 |
| CUMULATS | 0.382 | 0.356 | 0.262 | 0.115 | 0.080 | 0.080 | 0.035 |

TABLE 2.2
Joint Event Proportions FUS

| | A | B | C | AB | BC | AC | ABC |
|---|---|---|---|---|---|---|---|
| OCURRENCES | 86 | 79 | 60 | 35 | 18 | 20 | 17 |
| MOMENTS | 0.382 | 0.351 | 0.267 | 0.156 | 0.080 | 0.089 | 0.076 |
| CUMULANTS | 0.382 | 0.356 | 0.262 | 0.021 | −0.014 | −0.013 | 0.044 |

The second order moments represent the probability of joint pair-wise point events, and the third order moment represents the joint probability of triple point events. The moments are redundant; therefore, the third order moment also includes the second order moment occurrences within the triple array. The third order moment can be decomposed as a combination of cumulants as is indicated in Equation 1. The three cumulants are the mean, variance and a pseudo-skewness of the indicators (Tables 2.1 and 2.2, last rows). In actual spatial estimation, cumulants are used instead of moments because they are addible. Thus, they allow for higher order sequential kriging estimation (Vargas-Guzmän, 2008).

Tables 3.1 and 3.2 provide conditional probabilities computed with the Bayesian relation described in Equation 2.

TABLE 3.1
Conditional Probabilities for CUS

| | | | |
|---|---|---|---|
| P(A\|B) | 0.709 | P(C\|AB) | 0.643 |
| P(B\|C) | 0.650 | P(A\|BC) | 0.923 |
| P(A\|C) | 0.683 | P(B\|AC) | 0.878 |

TABLE 3.2
Conditional Probabilities for FUS

| | | | |
|---|---|---|---|
| P(B\|A) | 0.407 | P(C\|AB) | 0.486 |
| P(C\|B) | 0.228 | P(A\|BC) | 0.944 |
| P(C\|A) | 0.233 | P(B\|AC) | 0.850 |

The probability of triple events given pair-wise events is high in the example, but that is not a general result. In some cases, triple events could be rarer than pair-wise occurrences. More advanced analysis may imply the simulation of joint events, outside well bores and in 3D. This is described later. The example in this section is particularly useful to go beyond the so called Markovian transition probabilities for simple pair-wise events. The approach described in the example allows for multiple point statistical treatment of sequences for modeling purposes.

### From Proportions of Joint Events to Cumulates

The present invention thus provides quantification of tensorial anisotropy and structures of directional variability extracted from analog satellite images and well data. These techniques may also be applied in other areas where multipoint statistics and other object modeling are to be used.

The relations among indicators are functions of the expected proportion E (I)=f. Note that f is the average proportion or number of times that an occurrence or rock happens in a sequence divided by the total number of samples. This gives the variance c(0)=f(1−f). Quantitative geologists are familiar with the fact that variance c(0)=f(1−f) is the sill of the indicator variogram. However, as indicated before, covariances or variograms only account for pair-wise variability because they can be computed from two samples correlated at a time.

The correlation of three points requires a more advanced measure. FIG. 7 shows the plots of novel cumulant polynomials which relate the probability of an occurrence (i.e., proportion of outcomes) to the value and shape of the indicator cumulant function. These plots come from the following equations. A third order cumulant is κ₃=f−3(f−f²)f−f³, where f is the proportion of events, and κ₃ represents a pseudo skewness for three indicators. A four order cumulant is κ₄=f−7f²+12f³−6f⁴. The fifth order cumulant considers five point indicator variables, and this is κ₅=f−15f²+57f³−81f⁴+38f⁵.

FIG. 8 demonstrates that the shape of rock bodies can be related to the order of the uncertainty associated with non-sampled locations. With samples at two locations the uncertainty at the sampled wells is zero. The uncertainty on the expected proportion at points located between sampled wells is parabolic as indicated at 80. Therefore, the uncertainty is maximum at the middle point between two sampled (cored) wells under symmetric variability. For three sample points, the sample locations in a third order κ₃ model coincide with the zero cumulant. The uncertainty forms a sinusoidal type of uncertainty curve as indicated at 82, unless the samples are symmetric pair-wise. The same principle is extended for higher orders. The curve 84 is for the fourth order κ₄, and the curve 86 for the fifth order κ₅. For a large number of realizations in a 3D rock model, after computing the average proportion of predicted rock categories, the cumulants in FIG. 8 should respond to the expected geometries. The same principle is also applied to the study of vertical successions of rocks, and of satellite images.

A practical input from the present invention to facies modeling is the statistical distributions to draw objects using deformed versions of the polynomials in FIG. 8. Then, the objects are re-assembled with an optimization modeling approach. It is to be noted that connectivity is broken due to lack of higher order terms above fifth order. One way to improve the object modeling of facies is by swapping objects until they optimize an objective function driven by higher order cumulants. The approach is the same as usually utilized with second order structures. The object elements of geobodies are swapped until the difference between a target cumulant function extracted from images and the sample cumulants computed in the object modeling realization is minimized for a given category.

### Simulation of Rock Types Within Geobodies

Modeling of geobodies or depositional facies is unavoidable for a realistic prediction of rocks at non-sampled locations between wells. These tasks require the correct use of tensorial anisotropy. The distribution of fluids in a reservoir is driven by the quality (pore size and pore connectivity) of rocks. A usual practice is to define rock types (RT) based on a relation between the permeability coefficient k and porosity φ, such as \sqrt{k/φ}, or other rock quality indices. Rock types may also be related to litho-facies at least in the local framework. It has been found that simulating rock types according to the inputs of the present invention following CUS or FUS constraints within previously delimited geobodies is a rewarding practice because it leads to reproduced rock types and lithofacies successions as expected in the more general frame within geobodies.

### Dynamic Inverse Conditioning of Geobodies

The parameters from the present invention can be modified iteratively using inverse solutions. The practical modeling approaches have demonstrated that dynamic sedimentary constraints imprinted in the derivative of gamma ray help to construct the expected fining or coarsening upwards sequences. A more advanced way to achieve such a conditioning is by running a transport equation. For example, inverse conditioning using well known flow and transport forward modeling packages are used. A suitable forward simulation program based on flow dynamics is “SEDSIM” as described in “Simulating elastic sedimentation,” Tetzlaff, D. M., and Harbaugh, J. W., 1989, Computer methods in the geosciences: Van Nostrand Reinhold, (1989). This simulation technique can also be used to solve a transport Navier-Stokes differential equation to produce the distribution of deposited sediments. The input constraints are boundary and initial conditions. An initial condition is the base surface of the basin, and boundaries are sediment supply sources. Since those paleo-conditions are heterogeneous and unknown at present, the approach can not directly honor well observations.

A complementary solution is a stochastic inverse approach as follows: The transport model can be solved with arbitrary (best guess) initial parameters. The resulting model of rocks is obtained after compacting and deforming the result to observed conditions, using the present invention. To de-compact rocks one can see the approach proposed in: “Stripper: An interactive backstripping, decompaction and geohistory program”, Gidner, R. F., Cross T. (Ed.), Quantitative Dynamic Stratigraphy: Prentice Hall, N.J., p. 165-180 (1989).

### Cross-Cumulants Among Rock Bodies

### Classic Indicator Covariance, The Second Order Co-Cumulant

A measure of the covariance is an indication of the residual similarity between events, after removing their independent effect or product of first order terms P(A)P(B). The removal operation yields the covariance which is defined according to the present invention as a residual of the second-order-moment or co-cumulant, and this is

c(Iₚ,I_{q})=P(A∩B)−P(A)P(B) (3)

It is well known that under a stationary model P(A)=P(B)=E[I], and P(A∩B)=E[IₚI_{q}] where Iₚ=1 indicates the first event has occurred, and I_{q}=1 indicates the second event has also occurred.

### The Indicator Variogram and Non-Intersection Probability

The variance minus the covariance is known as the variogram, this gives

γ_{AB}=P(A)(P(A^{c})+P(B))−P(A∩B) (4)

Under the statistical principle of stationarity, P(A)=P(B); then, the variogram can also be written as

γ_{AB}=P(A)P(A∩B)−P(A∩B) (5)

The indicator variogram is the residual probability of all dissimilar events

γ_{AB}=P(A)−P(A∩B) (6)

And this yields

$${γ}_{AB} = \frac{1}{2} {P ( A ⋂ B )}^{c} \qquad ( 7 )$$

Using indicators is straight forward, and the indicator variogram is

γ_{pq}=E[I]−E[IₚI_{q}] (7a)

### Indicator Estimation

If the event A represents data and B is to be estimated, a first step sequential indicator kriging is well known, as

E[I_{q}|Iₚ]=θₚ^{q}(Iₚ−E[Iₚ])+E[I_{q}] (8)

Since E[Iₚ]=E[I_{q}] due to stationary, then

E[I_{q}|Iₚ]=θₚ^{q}Iₚ+E[I](1−θₚ^{q}) (9)

The weight θₚ^{q} in terms of the classic least squares and events is also known, as

$${θ}_{A}^{B} = \frac{P ( A ⋂ B ) - P ( A ) P ( B )}{P ( A ) P ( {A}^{c} )} \qquad ( 10 )$$

Where P(A)P(A^{c}) is the variance of I_{A}

From Equation 10 one gets

$${θ}_{A}^{B} = \frac{P ( B \vert A ) - P ( B )}{P ( {A}^{c} )}$$

And this yields

P(B|A)=(1−P(A))θ_{A}^{B}+P(B) (11)

Compare this equation to the simple kriging estimator in Equation 8 with Iₚ=1 and E(I_{q})=P(B).

If Equation 9 is written with probabilities, and P(A)=P(B), Equation 11 becomes P(B|A)=(1−θ_{A}^{B})P(A)+θ_{AB}Iₚ. If Iₚ=1; then, the estimator is P(B|A)−P(A)=θ_{A}^{B}(1−P(A)); where 1−P(A) is residual probability data, and P(B|A)−P(A) is a residual probability estimated to update the conditional distribution functions or cdf's.

Under the “second order” sequential kriging estimator, a third event can be estimated as follows,

P(C|A,B)=θ_{(B|A)}^{C}(I_{B}−(θ_{A}^{B}(I_{A}−P(A))+P(B)))++θ_{A}^{C}(I_{A}−P(A))+P(A) (12)

Then, P(C|A,B)−P(C|A)=θ_{B|A)}^{C}(I_{B}−P(B|A)), where the left hand side is a residual conditional probability. The sequential kriging weights θₗ^{J} are ratios of residual conditional covariances θᵢ^{j}=ξᵢⱼ/ξₗₗ.

This following section shows that (cross) moments do not guarantee truly higher order composition of expectation of indicator variable products. Moreover, truly higher order data redundancy requires a more advanced treatment using co-cumulants as follows.

### Spatial Indicator Functional Co-Cumulants

The co-cumulants of order G relate n=G variables. If the variables are separated by lag distances h_{pq}, and they are stationary for every lag distance, then the co-cumulants can be parametric functions κ(h_{pq}). The second order co-cumulant is the covariance, this is c(h)=κ(h_{pq}). The bilinear co-cumulant is a function of two lag distance κ(h_{pq},h_{qr}); and in general, the nth order co-cumulant is a function of n−1 lag distances. A simple exponential model is for example κ(h₁,h₂)=k(0,0)exp(a₁h₁+a₂h₂). These models can be extended from all the known positive definite covariance models. The third order co-cumulant can be plotted as a surface but higher order co-cumulants are not plotted and their management is in the hyperspace.

### Probability of Multiple Joint Events

The probability of multiple events occurring simultaneously is

P(A∩B∩C∩ . . . N)=E[IₚI_{q}Iᵣ . . . Iₙ]

A higher order conditional probability is P(N|(A∩B∩C∩ . . . N−1)). The joint prior event is (A∩B∩C∩ . . . N−1). From the previous sections one can induce the following

$$P ( N \vert ( A ⋂ B ⋂ C ⋂ … N - 1 ) ) = \frac{P ( A ⋂ B ⋂ C ⋂ … N )}{P ( A ⋂ B ⋂ C ⋂ … N - 1 )} \qquad ( 13 )$$

and

P(A∩B∩C∩ . . . N)=P(N|(N−1∩N−2∩ . . . ∩A)) . . . P(C|(A∩B))P(B|A)P(A)

The co-cumulates for four and fifth order follow the known equations from residuals of higher order moments. The tri-linear and tetra-linear cumulogram (i.e., a higher order variogram) is the nth order cumulant minus the nth order co-cumulant. This is

γ(hₚᵣ,h_{qr} . . . h₍ₙ₋₁₎ᵣ)=κ^{(pq . . . n)}(0,0)−κ(hₚᵣ,h_{qr} . . . h₍ₙ₋₁₎ᵣ)

It has been found that the sum of a cumulogram and a co-cumulant gives a cumulant at zero lag distances. This is analogous to saying that the sum of a covariance and the variogram yields the variance. The cumulogram and cross-structures are needed for comparisons and spatial estimations.

From the foregoing, it can be seen that the present invention performs various operations that range from basic steoreonet analysis of simple 3D objects to more complex analysis of rock bodies (e.g., dunes, meandering channels, braided channels, deltas, and the like). Although the present invention is based on application of mathematical spatial-statistics relations to geobodies, expert knowledge and the flow mechanics of deposition may be built in, for case-specific problems.

The present invention utilizes physical measurements and images taken from an area of interest in the planet and provides measures of tensor anisotropy of heterogeneity of complex rock objects or areas in the area of interest. The present invention determines the tensor structure of multiple orientations interactively pointed from plots made by a stereographic projection plotting methodology known as stereonet. Directions are then chosen and the cross-cumulant computations are imbedded into the tensor as provided from the stereonet. The structural relations obtained among rock bodies or complex objects go beyond classic covariances, variograms and trivial correlations. A stereonet plot enables mathematical analysis to assure that the physical spatial distribution of rocks in the vertical direction is not independent of the lateral direction. Thus the anisotropy is described by a tensor of higher-order relations rather than independent directional components. Indeed, the methodology of the present invention is available not only for predicting rocks, but for studying other anisotropic phenomena.

For curvilinear bodies (e.g., meandering and braided channels). Walther's law depends on complex curvilinear axes of anisotropy. Such problem requires the abstraction of using tensors with higher order cumulants for multiple directions. This leads to non-stationary anisotropy which is a function of proportions. As has been set forth, the present invention permits study and analysis of such higher order non-linear correlation between rock properties, data measurement derivatives and images.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A computer implemented method of subsurface directional analysis of an area of interest with rock bodies having geological trends in the earth, the analysis having input data including geobody data and categorical data regarding the area of interest, the computer implemented method comprising the steps of:
forming a measure of postulated proportions of rock joint events in the geological trends in the area of interest;
forming a measure of spatial tensorial relations for projections along directions of the geological trends in the area of interest based on the measure of postulated proportions of rock joint events;
projecting the categorical data onto the measure of spatial tensorial relations;
determining cross-structural relationships between the projected categorical data and the measure of spatial tensorial relations for expected pairs of directions and rock categories;
equalizing the measure of spatial tensorial relations and the projected categorical data to form a meta-model of facies present in the area of interest and their directions;
forming a record of the meta-model of facies.

2. The computer implemented method of claim 1, wherein the step of determining cross-structural relationships between the projected categorical data and the measure of spatial tensorial relations comprises the step of:
forming a measure of the joint probability of a rock sequence in the measure of spatial tensorial relations.

3. The computer implemented method of claim 2, wherein the step of forming a measure of the joint probability of a rock sequence comprises the step of:
forming a measure of at least three rock bodies in a succession of rock sequences.

4. The computer implemented method of claim 1, further including the step of
forming a measure of cross-cumulants among the measures of postulated proportions of rock joint events in the geological trends in the area of interest.

5. The computer implemented method of claim 1, wherein the categorical data includes well data and data from a satellite image, and wherein the step of equalizing measure of spatial tensorial relations comprises the step of:
projecting the well data onto a lateral surface covered by the satellite image.

6. The computer implemented method of claim 5, wherein the step of equalizing measure of spatial tensorial relations further comprises the step of:
adjusting the satellite image data to maximize the cross-correlation between a well in the well data and lateral projections of the satellite image.

7. The computer implemented method of claim 6, wherein the step of equalizing measure of spatial tensorial relations further comprises the step of:
forming a prediction of the adjusted satellite image from the well data.

8. The computer implemented method of claim 1, wherein the step of forming a record of the meta-model of the facies comprises the step of:
storing the record of the meta-model of the facies in a data memory.

9. The computer implemented method of claim 1, wherein the step of forming a record of the meta-model of the facies comprises the step of:
forming an output display of the meta-model of the facies.

10. A data processing system for subsurface directional analysis of an area of interest with rock bodies having geological trends in the earth, the analysis having input data including geobody and categorical data regarding the area of interest, the data processing system comprising:
a processor for performing the steps of:
forming a measure of postulated proportions of rock joint events in the geological trends in the area of interest;
forming a measure of spatial tensorial relations for projections along directions of the geological trends in the area of interest based on the measure of postulated proportions of rock joint events;
projecting the categorical data onto the measure of spatial tensorial relations;
determining cross-structural relationships between the projected categorical data and the measure of spatial tensorial relations for expected pairs of directions and rock categories;
equalizing the measure of spatial tensorial relations and the projected categorical data to form a meta-model of facies present in the area of interest and their directions; and
forming a record of the meta-model of facies.

11. The data processing system of claim 10, wherein the step of determining cross-structural relationships between the projected categorical data and the measure of spatial tensorial relations performed by the processor comprises the step of:
forming a measure of the joint probability of a rock sequence in the measure of spatial tensorial relations.

12. The data processing system of claim 11, wherein the step of forming a measure of the joint probability of a rock sequence performed by the processor comprises the step of:
forming a measure of at least three rock bodies in a succession of rock sequences.

13. The data processing system of claim 10, further including the processor performing the step of:
forming a measure of cross-cumulants among the measures of postulated proportions of rock joint events in the geological trends in the area of interest.

14. The data processing system of claim 10, wherein the categorical data includes well data and data from a satellite image, and wherein the step of equalizing measure of spatial tensorial relations performed by the processor comprises the step of:
projecting the well data onto a lateral surface covered by the satellite image.

15. The data processing system of claim 15, wherein the step of equalizing measure of spatial tensorial relations performed by the processor further comprises the step of:
adjusting the satellite image data to maximize the cross-correlation between a well in the well data and lateral projections of the satellite image.

16. The data processing system of claim 15, wherein the step of equalizing measure of spatial tensorial relations performed by the processor further comprises the step of:
forming a prediction of the adjusted satellite image from the well data.

17. The data processing system of claim 10, further including:
a data memory storing the record of the formed meta-model of the facies.

18. The data processing system of claim 10, further including:
an output display forming an image of the formed meta-model of the facies.

19. A data storage device having stored in a computer readable medium computer operable instructions for causing a processor to perform subsurface directional analysis of an area of interest with rock bodies having geological trends in the earth, the processor having as input data geobody and categorical data regarding the area of interest, the instructions stored in the data storage device causing the processor to perform the following steps:
forming a measure of postulated proportions of rock joint events in the geological trends in the area of interest;
forming a measure of spatial tensorial relations for projections along directions of the geological trends in the area of interest based on the measure of postulated proportions of rock joint events;
projecting the categorical data onto the measure of spatial tensorial relations;
determining cross-structural relationships between the projected categorical data and the measure of spatial tensorial relations for expected pairs of directions and rock categories;
equalizing the measure of spatial tensorial relations and the projected categorical data to form a meta-model of facies present in the area of interest and their directions; and
forming a record of the meta-model of facies.

20. The data storage device of claim 19, wherein the stored instructions cause the processor in performing the step of determining cross-structural relationships between the projected categorical data and the measure of spatial tensorial relations comprises the step of:
forming a measure of the joint probability of a rock sequence in the measure of spatial tensorial relations.

21. The data storage device of claim 20, wherein the stored instructions cause the processor in performing the step of forming a measure of the joint probability of a rock sequence to perform the step of:
forming a measure of at least three rock bodies in a succession of rock sequences.

22. The data storage device of claim 19, further including the instructions causing the processor to perform the step of:
forming a measure of cross-cumulants among the measures of postulated proportions of rock joint events in the geological trends in the area of interest.

23. The data storage device of claim 19, wherein the categorical data includes well data and data from a satellite image, and wherein the stored instructions cause the processor in performing the step of equalizing measure of spatial tensorial relations to perform the step of:
projecting the well data onto a lateral surface covered by the satellite image.

24. The data storage device of claim 23, wherein the stored instructions cause the processor in performing the step of equalizing measure of spatial tensorial relations further comprises the step of:
adjusting the satellite image data to maximize the cross-correlation between a well in the well data and lateral projections of the satellite image.

25. The data storage device of claim 24, wherein the stored instructions cause the processor in performing the step of equalizing measure of spatial tensorial relations further comprises the step of:
forming a prediction of the adjusted satellite image from the well data.

26. The data storage device of claim 19, wherein the step of forming a record of the meta-model of the facies comprises the step of:
storing the record of the meta-model of the facies in a data memory.

27. The data storage device of claim 19, wherein the stored instructions cause the processor in performing the step of forming a record of the meta-model of the facies to perform the step of:
causing a display device to form an output display of the meta-model of the facies.
